(19) United States
(12) Patent Application Publication
(10) Pub. No.: US 2010/0250522 A1
(43) Pub. Date: Sep. 30, 2010

(54) USING ONTOLOGY TO ORDER RECORDS BY RELEVANCE

(75) Inventor: Sugato Chakrabarty, Bangalore (IN)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., Detroit, MI (US)

(21) Appl. No.: 12/414,399

(22) Filed: Mar. 30, 2009

(51) Int. Cl. G06F 17/30

(52) U.S. Cl. 707/723; 707/E17.014

(57) ABSTRACT

A method for retrieving records in an order of relevance based on a pre-defined domain ontology. The relevance of each result of the search conducted is decided on the basis of the pre-defined domain ontology. The method includes obtaining a search query as an input from the user containing one or more than one phrases. Then, the set of results from the given set of records is retrieved based on the input search query. The method further includes calculating and assigning a closeness parameter corresponding to each result of the set of results based on the domain ontology. Finally, the set of results is displayed in an order of relevance by sorting in an ascending order the closeness parameter of each of the record present in the set of results.

### BACKGROUND OF THE INVENTION

1. Field of the Invention

This invention relates generally to a method for searching records and, more particularly, to a method for searching a set of results in a database using a search query and displaying the results in order of relevance using a pre-defined domain ontology.

2. Discussion of the Related Art

Information is the most important asset of any organization either small or big. Managing stored information is one of the biggest challenges organizations all over the world are facing. The problem of wading through voluminous databases and fetching a record that is most relevant to a users query is of great priority. This problem holds equal relevance in the automobile industry. Search engines have almost become indispensable as efficient data retrieval systems in the automobile industry. The search engines available presently are mostly matching engines that match the words of a user's search query to the data available in the databases and fetch the records on the basis of that match. However, only a few search engines are available that employ additional logic for mining of data. Further, some of the present search engines do not even display the retrieved records in an order of relevance of the records to the typed in query. This sometimes leads to a user missing some of the most relevant records as the attention span of any user is limited. Thus, a need arises to develop a better strategy for a data retrieval system that displays the retrieved records based on their relevance to the typed query as this saves the time and effort of the user.

Search engines in general use a word based or a character based search. However, while retrieving and displaying the results of a search query, a search engine only gives preference to the number of occurrences of the query in the document, but not to the domain or the closeness of the query to the domain.

In other existing search strategies or engines used for a particular domain, such as automobiles, non-ontology based methods are used. In such methods, relevance of a result of the search query is affected by its closeness to the area of interest of the user, but that closeness is decided only on the basis of the text contained in the result and not on the basis of the concepts contained in it.

### SUMMARY OF THE INVENTION

In accordance with the teachings of the present invention, a method for retrieving the results of a search query based on domain ontology is disclosed that has a particular application in displaying a set of results in an order of relevance, where the relevance of each result is decided on the basis of the domain ontology. In this method, the set of results to be displayed is obtained on the basis of a search query. The search query is input by the user and comprises one or more phrases, where each of the phrases is made of at least one word. The method includes selecting a first set of phrases from the one or more phrases of the search query such that each phrase of the first set of phrases is present in the pre-defined domain ontology. The method further includes retrieving the set of results to be displayed from a given set of records such that at least one phrase of the search query is present in each of the result. Further, a second set of phrases corresponding to each result of the set of results is obtained such that each phrase of the second set of phrases is present in the pre-defined domain ontology and in each result of the set of results. A closeness parameter corresponding to the each result of the set of results is then obtained on the basis of a pre-defined relationship between each phrase of the second set of phrases corresponding to each result of the set of results and each of the set of phrases, where the pre-defined relationship is based on the pre-defined domain ontology. Finally, the set of results is displayed in the order of relevance, where the relevance of each result of the set of results is based on the closeness parameter of each result of the set of results.

Additional features of the present invention will become apparent from the following description and appended claims, taken in conjunction with the accompanying drawings.

### BRIEF DESCRIPTION OF THE DRAWINGS

FIG. 1 is a flow chart diagram showing a method used to display the results of a search query in an order of relevance decided using ontology;

FIG. 2 is a flow chart diagram showing a process for determining the rank of records in the flow chart diagram shown in FIG. 1;

FIG. 3 illustrates an example of a domain ontology and shows part of the topology; and

FIG. 4 is a block diagram illustrating a system for addressing a search query using the ontology.

### DETAILED DESCRIPTION OF THE EMBODIMENTS

The following discussion of the embodiments of the invention directed to a method for retrieving records in order of relevance based on domain ontology is merely exemplary in nature, and is in no way intended to limit the invention or its applications or uses. For example, the method for retrieving records in order of relevance based on domain ontology of the invention has specific application in a customer friendly warranty database or a database comprising the history of events occurring in a manufacturing unit. However, as will be appreciated by those skilled in the art, the method for retrieving records in order of relevance based on domain ontology may have other applications.

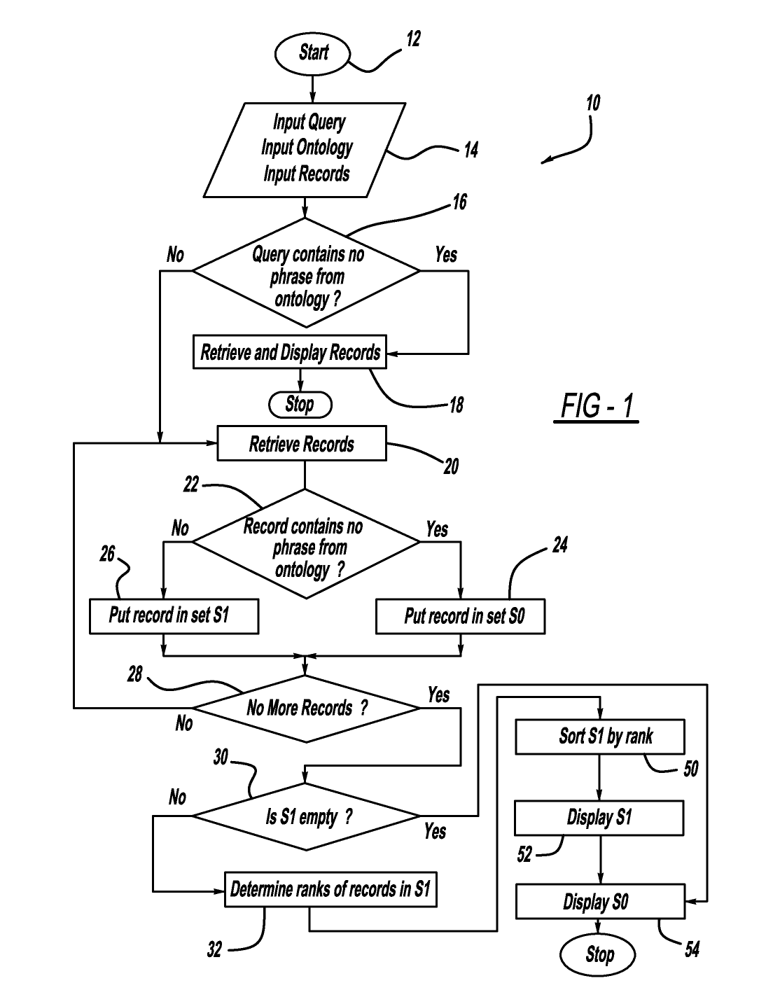

FIG. 1 is a flowchart 10 that illustrates a method that uses ontology to decide the relevance of the results of a search query. The method is initiated at oval 12. At box 14, a search query from a user, a domain ontology and a set of records or a database, hereinafter used interchangeably, are input to perform the search. Ontology in general represents a set of concepts within a domain and the relationships between those concepts. Domain ontology models a specific domain and explains the meaning of terms as they apply to that domain. The domain can be selected from one or more domains, such as automotives, computers, embedded systems and mechatronics, but not limited to these alone. A subject matter expert in a specific domain is generally the designer of the domain ontology. Designing of the ontology involves establishing relationships among the various concepts present in the domain. In the ontology under consideration, for each relationship, the subject matter expert also prescribes a positive integer value that shows the closeness of the relation (the smaller the value, the closer the relationship). Typically, the task of creating the ontology involves picking up related elements or phrases from the domain and establishing a relationship between two phrases by assigning values to them.

The domain expert continues this process of picking up phrases and establishing relationships between them with their closeness, and thus, inter-connects all of the phrases to form a topology and thus an ontology. The topology can assume many forms and the most common is a tree-like structure clearly representing the relationship among each element, that is, each phrase. Further, the ontology can be updated and also expanded whenever new phrases are available. These features of ontology thus prove helpful if integrated into a search algorithm. The search query given by the user at the box 14 contains one or more phrases.

At decision diamond 16, the algorithm determines whether the query contains no phrase from the ontology, and if so, retrieves and displays the records at box 18. If the query does contain a phrase from the ontology at the decision diamond 16, then the algorithm retrieves the records at box 20 and then determines whether the record again contains no phrase from the ontology at decision diamond 22. If the record does not contain a phrase from the ontology at the decision diamond 22, then the algorithm puts the record in the set SO at box 24, otherwise it puts the record in the set S1 at box 26. Then, the algorithm determines whether there are any more records at decision diamond 28, and if there are, returns to the box 20 to retrieve more records. Otherwise, the algorithm determines whether the set S1 is empty at decision diamond 30, and if the set S1 is not empty determines the rank of the records in the set S1 at box 32.

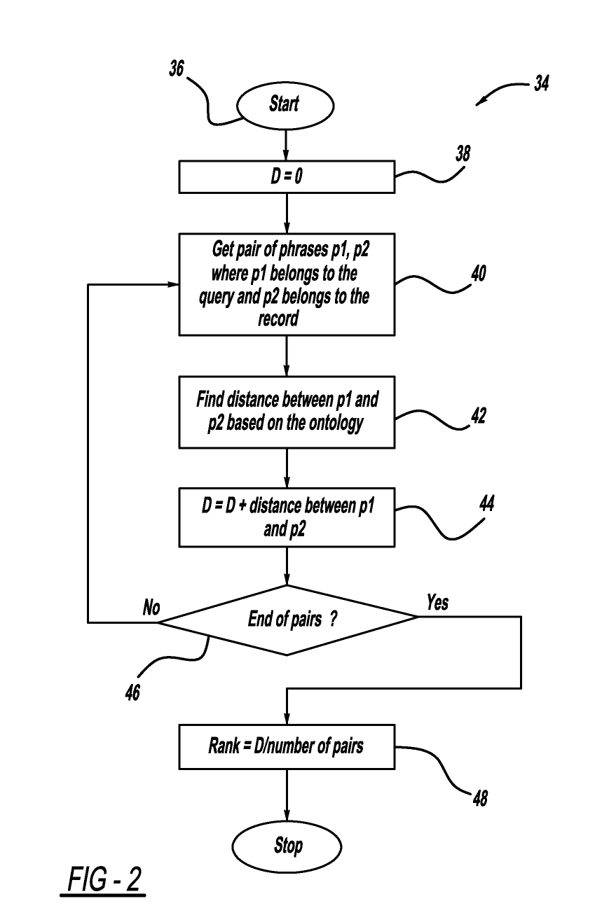

FIG. 2 is a flow chart diagram 34 showing a process for determining the rank of the records at the box 32 which starts at oval 36 and sets variable D=0 at box 38. The algorithm then gets a pair of phrases p1 and p2 at box 40 where p1 belongs to the query and p2 belongs to the record. The algorithm then finds the distance between the phrases p1 and p2 based on the ontology at box 42 and sets D=D plus the distance between the phrases p1 and p2 at box 44. The algorithm then determines whether the algorithm has reached the end of pairs of phrases at decision diamond 46, and if not, returns to the box 40 to get the next pair of phrases p1 and p2. If the algorithm determines that the pairs of phrases have ended at the decision diamond 46, then the algorithm ranks the number of pairs at box 48 as D/number of pairs.

Returning to FIG. 1, after the algorithm determines the ranks of the records of the box 32, it sorts the set S1 by rank at box 50 and displays the set S1 at box 52. If the set S1 is empty at the decision diamond 30 and after the set S1 is displayed, the set SO is displayed at box 54.

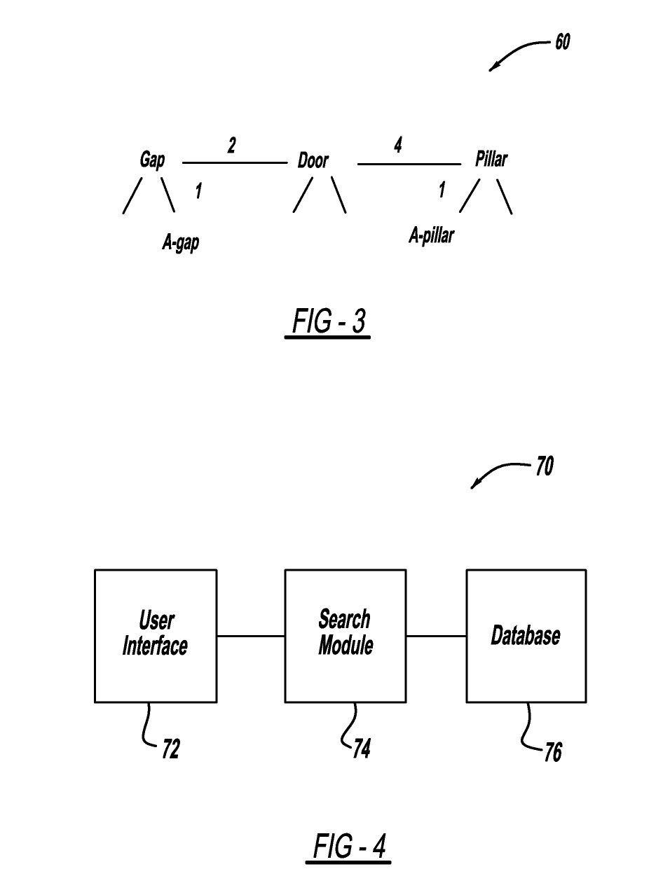

FIG. 3 is a small section 60 of an ontology belonging to the domain of automobiles showing the topological interconnection between the word “door” and other phrases or words related to it. The section 60 illustrates an exemplary scenario where a user inputs a search query that is composed of a phrase containing a single word “door” to search in a set of records belonging to the domain of automobiles. First, the results that contain the word “door” are retrieved from the set of records and populated in the result set. Now, the word “door” is searched in the domain ontology. The word “door” is shown to share a pre-defined relationship with two terms, namely, “gap” and “pillar”. “Gap” and “pillar” are in turn connected to “A-gap” and “A-pillar” in the topology. The result set thus created contains two results, result 1 in which the phrase “A-gap” is present and result 2 in which the phrase “A-pillar” is present. A second set of phrases are obtained from results 1 & 2 and those phrases should be present in the domain ontology. The phrases obtained from result 1 will be “A-gap” and result 2 will be “A-pillar”.

The order of relevance in which these records will be displayed in the final result set depends the closeness parameter assigned to them. The closeness parameter is calculated as described in FIG. 1. The shortest distance calculated between (pair 1) “door” & “A-gap” and (pair 2) “door” & “A-pillar” is 3 and 5, respectively. The closeness parameter in this case is equal to the shortest distance as the search query is composed of a phrase containing a single word and not multiple phrases. Now, the two results are sorted in an ascending order of their closeness parameter and displayed to the user. It can be seen that the result containing the phrase “A-gap” is more relevant and is listed before the result containing the phrase “A-pillar”.

FIG. 4 is a block diagram illustrating a system 70 for addressing a search query using ontology. The system 70 is shown to include a user interface 72 for receiving the search query. The search query is as described in FIG. 1. The search query is then fed to a search module 74. The search module 74 is further connected to a database 76 containing a set of records pertaining to the domain in which the system 70 is being applied. The search module 74 receives the search query from the user interface 72 and selects a set of results from the records contained in the database 76. The results are selected using the process described in FIG. 1. The search module 74 further sorts the selected results in an order of relevance based on the closeness parameter of each result. The process of sorting the results is as described in FIG. 1. In one embodiment, the search module 74 is used to calculate the closeness parameter of each result using the process described in FIG. 1. Finally, the set of results is displayed in the order of relevance through the user interface 72.

Various embodiments of the present invention offer one or more advantages. The present invention provides a method for searching results and displaying them in an order of relevance using ontology. The method uses a unique search strategy to search and list more relevant records before less relevant ones and ensures that a relevant result is not missed out because of the limited attention span of the user.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for displaying a set of results of a search query in an order of relevance, wherein the set of results is selected from a given set of records, wherein the given set of records belong to a domain, wherein the domain has a pre-defined domain ontology, wherein the search query is input in a form of one or more phrases, wherein each of the one or more phrases is made of at least one word, the method comprising:
selecting a first set of phrases from the one or more phrases of the search query, wherein each phrase of the first set of phrases is present in the pre-defined domain ontology;
retrieving the set of results from the given set of records, wherein at least one phrase of the one or more phrases of the search query is present in each result of the set of results;
obtaining a second set of phrases corresponding to each result of the set of results, wherein each phrase of the second set of phrases is present in the pre-defined domain ontology and in the each result of the set of results;
obtaining a closeness parameter corresponding to each result of the set of results, wherein the closeness parameter is obtained on the basis of a pre-defined relationship between each phrase of the second set of phrases corresponding to the each result of the set of results and each phrase of the first set of phrases, wherein the pre-defined relationship is based on the pre-defined domain ontology; and
displaying the set of results according to the order of relevance, wherein the order of relevance is based on the closeness parameter of each result of the set of results.

2. The method according to claim 1 wherein the domain can be selected from a group comprising but not limited to automotives, computers, embedded systems, and mechatronics.

3. The method according to claim 1 wherein all the phrases of the domain ontology are inter-connected with each other in a given topology where the topology is established on the basis of each of the pre-defined relationship.

4. The method according to claim 3 wherein the pre-defined relationship between a given pair of phrase inter-connected in the topology is represented by a positive integer where the positive integer is assigned by a domain expert.

5. The method according to claim 3 wherein a smaller positive integer represents a closer relationship between the given pair of phrase.

6. The method according to claim 3 wherein the topology can be in the form of a tree.

7. The method according to claim 4 wherein the sum of all the positive integers found while traversing from a first phrase to a second phrase of the given pair of phrase is considered as the shortest distance between the given pair of phrase.

8. The method according to claim 1 wherein the closeness parameter corresponding to each result of the set of results is an average of the shortest distance between pairs of phrases that are formed by taking a phrase from the first set of phrases and the other phrase from the second set of phrases corresponding to the each result of the set of results.

9. The method according to claim 1 wherein the set of results are displayed according to the order of relevance by sorting the set of results in ascending order of the closeness parameter.

10. The method according to claim 1 wherein the given set of records is a database.

11. A system for addressing a search query, the system capable of being used in a domain, the domain having a pre-defined domain ontology, wherein the search query comprises one or more phrases, each of the one or more phrases being made of at least one word, the system comprising:
a user interface for obtaining the search query;
a database containing a set of records belonging to the domain; and
a search module for retrieving a set of results from the set of records contained in the database based on the search query, wherein the search module sorts the results in an order of relevance, the order of relevance being based on a closeness parameter corresponding to each result of the set of results, wherein the closeness parameter corresponding to a result is calculated based on the pre-defined domain ontology, wherein the set of results is displayed in an order of relevance through the user interface.

12. The system according to claim 11 wherein the domain ontology includes phrases inter-connected with each other in a given topology, wherein the topology is established on the basis of each of a pre-defined relationship.

13. The system according to claim 12 wherein the pre-defined relationship between a given pair of phrases inter-connected in the topology is assigned by a domain expert, wherein the pre-defined relationship is represented by a positive integer.

14. The system according to claim 12 wherein a smaller positive integer represents a closer relationship between the given pair of phrase.

15. The system according to claim 12 wherein the topology can be in the form of a tree.

16. The system according to claim 15 wherein the sum of all the positive integers found while traversing from a first phrase to a second phrase of the given pair of phrase is considered as the shortest distance between the given pair of phrase.

17. The system according to claim 15 wherein the closeness parameter corresponding to each result of the set of results is an average of the shortest distance between pairs of phrases that are formed by taking a phrase from a first set of phrases contained in the search query and another phrase from a second set of phrases contained to the each result of the set of results.

18. The system according to claim 11 wherein the set of results is sorted by arranging the closeness parameters of the results contained in the set of results in an ascending order.

19. The system according to claim 11 wherein the closeness parameter is calculated by the search module.

20. A method for addressing a search query, the method capable of being used in a domain, the domain having a pre-defined domain ontology, wherein the search query comprises one or more phrases, each of the one or more phrases being made of at least one word, the method comprising:
selecting a first set of phrases from the one or more phrases of the search query, wherein each phrase of the first set of phrases is present in the pre-defined domain ontology;
retrieving the set of results from a database, wherein at least one phrase of the one or more phrases of the search query is present in each result of the set of results;
obtaining a second set of phrases corresponding to each result of the set of results, wherein each phrase of the second set of phrases is present in the pre-defined domain ontology and in the each result of the set of results;
obtaining a closeness parameter corresponding to each result of the set of results, wherein the closeness parameter is obtained on the basis of a pre-defined relationship between each phrase of the second set of phrases corresponding to the each result of the set of results and each phrase of the first set of phrases, wherein the pre-defined relationship is based on the pre-defined domain ontology; and
displaying the set of results according to the order of relevance, wherein the order of relevance is based on the closeness parameter of each result of the set of results.
